(19) United States
(12) Patent Application Publication
(10) Pub. No.: US 2006/0015823 A1
(43) Pub. Date: Jan. 19, 2006

(54) DISPLAY AND PREVIEW METHOD FOR DISPLAY APPARATUS

(76) Inventors: Yi-Hsuan Chao, Taoyuan County (TW); Chien-Chun Lee, Taipei City (TW); Chih-Chieh Tan, Hsinchu County (TW); Hau-Wan Leung, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,968

(22) Filed: Jan. 28, 2005

(30) Foreign Application Priority Data
Jul. 15, 2004 (TW) 93121089

(51) Int. Cl. G06F 3/00

(52) U.S. Cl. 715/823; 715/838; 715/708; 715/821; 715/860

(57) ABSTRACT

A display and preview method for a display apparatus is disclosed. The display method provides a method of distinguishing a current preview image from other preview images on a screen. The display method includes proportionately enlarging the current preview image after a short period by using a different resolution so that the current preview image is clearly displayed. The preview method includes displaying the preview images one by one automatically until the preview images are all displayed similar to a slide show or a stop signal is issued by the user.

### CROSS-REFERENCE TO RELATED APPLICATION

This application claims the priority benefit of Taiwan application serial no. 93121089, filed Jul. 15, 2004.

### BACKGROUND OF THE INVENTION

1. Field of the Invention

The present invention relates to a display method. More particularly, the present invention relates to a preview display and an automatic previewing method.

2. Description of the Related Art

In a conventional electronic device such as a mobile phone, personal digital assistant and digital camera, the display system working in a thumbnail preview mode often uses an array of indicator frames to show the user all possible selections. According to the selected indicator frame, a user is presented with a preview image so that the reader may choose to progress up a level to perform another task such as reading, executing or enlarging and so on.

In a black-and-white display device (screen), only black, white and gray pixels are used in the indicator frame to distinguish one selected position from the background. However, with a color display device, the selected position is often distinguished from the background by the use of eye-catching bright colors.

FIG. 1 is a sketch showing the conventional method of displaying the indicator frames in the preview mode. As shown in FIG. 1, the left diagram indicates that the pointer is stationed on the first indicator frame so that a user may proceed to the next operating level from this first image point. When the user shifts from thumbnail 1 to thumbnail 2, the second indicator frame is selected so that the user may proceed to the next operating level from this second image point.

In the conventional technique, to implement the aforementioned functions, the system first downloads a page of thumbnails, in other words, an array of M×N thumbnails. In the example of FIG. 1, the system has set up a page with 3×3 thumbnails. Therefore, the system downloads 9 thumbnails. FIG. 2 shows two other thumbnail setups. In the diagram on the left side of FIG. 2, a page having a 3×2 array of thumbnails is set up and so 6 thumbnails have to be downloaded altogether. On the right side of FIG. 2, a page having a 4×3 array of thumbnails is set up and so 12 thumbnails have to be downloaded altogether.

No matter how many thumbnails are disposed on a screen page, the selected preview image has a size identical to other non-selected preview images. If the 9 preview images happen to have colors similar to the indicator frame, the contrast needed for detecting one from the others will be gone as shown in FIGS. 3A and 3B. Perhaps, adding more colors, varying the colors, using dash lines or introducing additional patterns to the indicator frame may ease the identification. Yet, a page of thumbnails each having a constant size often produces a monotony that misses out all the dynamics necessary for establishing an efficient human-machine interface when the user moves around the indicator frame.

### SUMMARY OF THE INVENTION

Accordingly, at least one objective of the present invention is to provide a displaying method for indicating the selected indicator frame under a preview mode. The method includes enlarging the selected indicator frame in a series of stages relative to other background indicator frames and establishing a dynamic man-machine interface that facilitates browsing.

At least a second objective of the present invention is to provide a previewing method. When the user has set to a rapid previewing mode or slide show mode, the system is programmed to enlarge the next preview image after a set period starting from the selected indicator frame until all the preview images are displayed or a stop signal is issued by the user. Thus, a rapid previewing is obtained automatically.

At least a third objective of the present invention is to provide a display apparatus that deploys the aforementioned displaying and previewing method. In the previewing mode, the preview image are proportionately enlarges relative to other preview images for improving the dynamics of the man-machine interface and automatically enlarging the next preview image to provide a rapid slide show.

To achieve these and other advantages and in accordance with the purpose of the invention, as embodied and broadly described herein, the invention provides a displaying method for a display apparatus. The method includes reading a plurality of raw images, compressing the raw images into fixed size and proportionally reduced thumbnail images and displaying the thumbnail images on the display apparatus. On receiving a first instruction signal, a system is programmed to extract the raw image corresponding to the instruction signal and compress the raw image into an indicator image having a size in-between the raw image and the thumbnail image. The indicator image is then displayed on the display apparatus to achieve the dynamical effect of enlarging in stages.

In the aforementioned displaying method, the thumbnail image is output to the display apparatus and then the raw image corresponding to the second instruction signal is retrieved when the system receives a second instruction signal. Thereafter, the raw image is compressed into an indicator image before displaying on the display apparatus.

According to the displaying method of one preferred embodiment of the present invention, the corresponding indicator image is displayed on the display apparatus a delay period after outputting the thumbnail image on the display apparatus to increase dynamic realism. During this delay period, the raw image is compressed and the indicator image is displayed.

The present invention also provides a previewing method for a display apparatus. The method utilizes the enlargement of indicator images in sequential stages. First, a plurality of raw images is read and then the images are compressed and displayed as thumbnail images. On receiving an instruction signal, a system is programmed to compress the raw images into indicator images. Thereafter, the indicator images are displayed on the display apparatus. After a specified period of time, the system will automatically display the next thumbnail on the display apparatus and compress the raw image into indicator image to display on the display apparatus according a system arranged or user preset displaying sequence. Therefore, the system will automatically preview each thumbnail repeatedly and display the indicator image until the preset sequence is finished or a stop signal is issued by the user to terminate the preview.

In one embodiment of the present invention, the previewing sequence in the previewing method includes moving from top to bottom and then from left to right. Alternatively, the previewing sequence in the previewing method includes moving from left to right and then from top to bottom. In whatever ways, the sequence of movement should in no way limit the scope of the present invention.

The present invention also provides a display apparatus comprising an image buffer storage device, a display buffer storage device, a processor and a display monitor. The image buffer storage device stores raw images. The processor is coupled to the image buffer storage unit for compressing the raw images to thumbnail images and indicator image and outputting a suitable image. The indicator images have a size greater than the fix size thumbnail images but smaller than the raw images. The display buffer storage unit is coupled to the image buffer storage unit and the processor for holding the thumbnail images or the indicator images temporarily and outputting the images to the display monitor.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 are diagrams showing the 3×3, 3×2 and 4×3 thumbnail images on a conventional page in a black-and-white preview mode.

FIGS. 3A and 3B are diagrams showing the 3×3 color indicator frames on a conventional page in a color preview mode.

FIGS. 4A and 4B are diagrams showing the 3×3, 3×2 and 4×3 indicator frames in a preview mode according to one embodiment of the present invention.

FIG. 5 is a flow diagram showing the displaying method on a display apparatus according to one embodiment of the present invention.

FIG. 6 is a flow diagram showing the steps in displaying images according to one embodiment of the present invention.

FIG. 7 is a diagram showing the enlargement of a thumbnail image according to one embodiment of the present invention.

FIG. 8 is a flow diagram showing the previewing method according to one embodiment of the present invention.

FIG. 9 shows an image previewing sequence having a left to right and then top to bottom algorithm.

FIG. 10 shows an image previewing sequence having a top to bottom and then left to right algorithm.

FIGS. 11A and 11B show improved previewing modes.

FIG. 12 is a diagram showing the relative configuration of various components in a display apparatus according to the present invention.

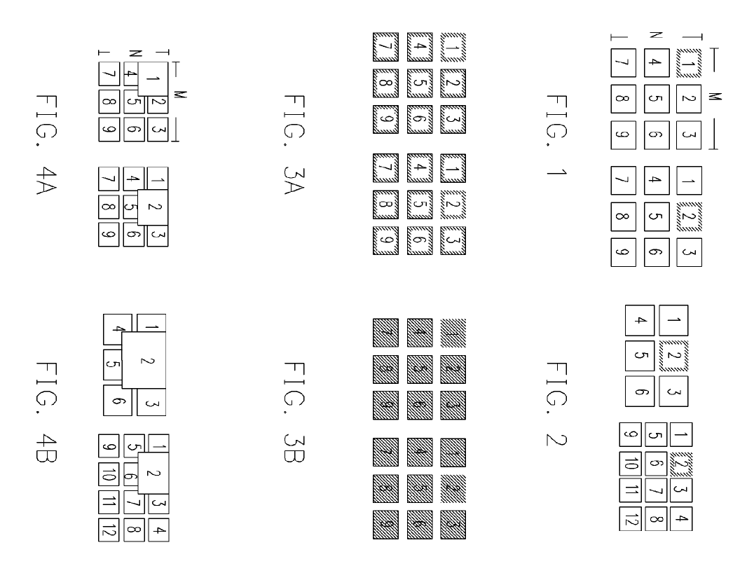

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

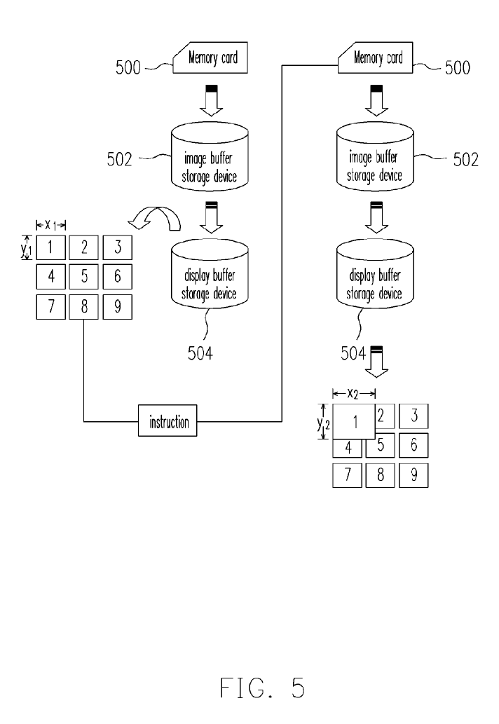

To combat the problems encountered in displaying the thumbnail within an indicator frame in FIGS. 3A and 3B, a new method of displaying previews is shown in FIGS. 4A and 4B. FIGS. 4A and 4B are diagrams showing the 3×3, 3×2 and 4×3 indicator frames in a preview mode according to one embodiment of the present invention. As shown in FIG. 4A, the indicator frame on the left side stations on the thumbnail image with the label 1 indicating that a user may progress to the next level of instructions from this image. Meanwhile, a system is programmed to compress the corresponding number 1 raw image into an indicator image and display that image so that the first thumbnail image appears to be magnified. When the user shifts from the number 1 thumbnail position to the number 2 thumbnail position as shown in the diagram on the right side of FIG. 4A, the indicator frame falls on the number 2 thumbnail. Hence, the corresponding number 2 raw image is compressed into an indicator image and displayed so that the second thumbnail image appears to be magnified. Thus, the user may progress to the next level of instructions from this number 2 image. When a particular thumbnail, say, the second one, is to be magnified on a page that can accommodate only 6 thumbnails per page or 12 thumbnails per page (as shown on the left and right side of FIG. 4A), the previewing image will be enlarged proportionately.

When the system steps into a preview mode for the thumbnail images, the system will download from a memory card 500 a screen page of thumbnails. As shown in FIG. 5, a total of nine raw images are downloaded into the image buffer storage device 502. These nine raw images are adjusted (compressed) to form thumbnails of identical dimension, download into the display buffer storage device 504 and output to the display apparatus. Thereafter, the raw data corresponding to the compressed image of the indicator frame is decoded and then transferred to the display buffer storage unit 504 before displaying on the display apparatus. In FIG. 5, the example is set for the number 1 thumbnail.

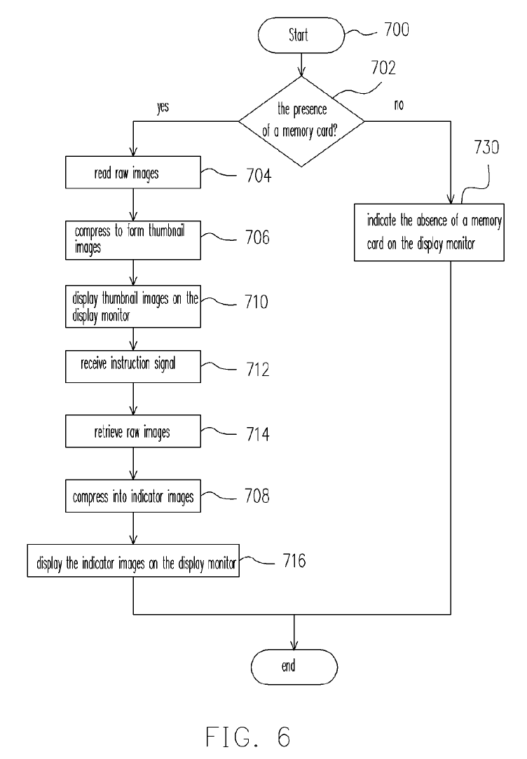

FIG. 6 is a flow diagram showing the steps in displaying images according to one embodiment of the present invention. To begin with, the system determines if the memory card exists or not (in step 702). If there is no memory card, the ‘no memory card’ message is displayed on the display monitor (in step 730). In the presence of a memory card, a plurality of raw images is read from the memory card (in step 704) and then compresses the raw images into thumbnail images (in step 706). Thereafter, the thumbnail images are displayed on the monitor (in step 710). When the system receives an instruction signal (in step 712), the raw data specified by the instruction signal is read from the memory card (in step 714) and compressed to form an indicator image (in step 708). The indicator image is displayed (in step 716). The indicator image has a dimension larger than the thumbnail image but smaller than the raw image.

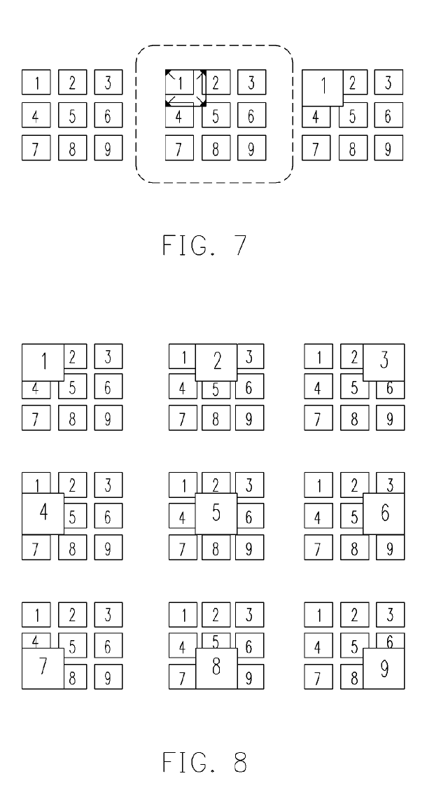

To improve the dynamic appeal of the displayed images, the present invention deploys a method of enlarging the image in stages. Using the aforementioned example as an illustration, the image as shown on the left side of FIG. 7 appears when the user steps into the preview operating mode. After the system has perform an image decoding treatment, the image as shown on the right side of FIG. 7 appears. Each time the user transmits an image inspection instruction; the thumbnail image is automatically enlarged in stages after the original thumbnail is displayed. In this way, the screen appears to have some dynamic response. After displaying the image shown on the left side of FIG. 7, there is a delay period before the image on the right side of FIG. 7 is displayed so that the user feels that the enlargement are completed in stages. During this delay period (in step 712), the raw image is compressed and the indicator image is displayed on the monitor (in step 716).

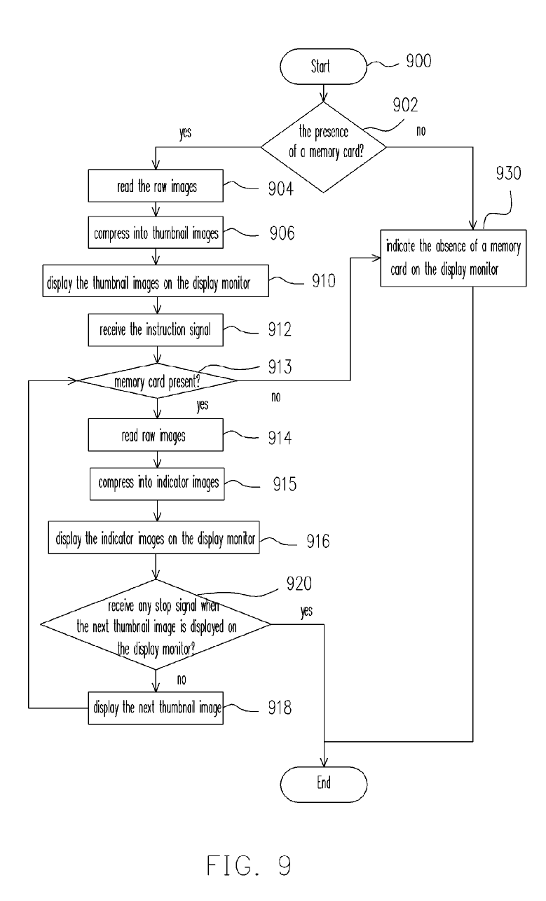

The present invention also provides a previewing method having a slide show function. FIG. 8 is a flow diagram showing the previewing method according to one embodiment of the present invention. The previewing method utilizes the aforementioned displaying method of showing various indicator images at a preset interval (steps 900 to 916) starting from the selected thumbnail. However, the previewing method does not require any resetting to the next indicator frame. Instead, the thumbnail image is displayed again on the monitor (in step 918) thereby returning to the original image after a specified interval. Thereafter, the system will automatically move the indicator frame to the next thumbnail and read the indicator image (in step 922) that corresponds to the thumbnail. If there is another thumbnail further down, the steps in 913 to 918 are repeated to retrieve the indicator image corresponding to the instruction signal and display the indicator image on the monitor. After the passage of a specified interval, the next thumbnail is selected as the image of the new indicator frame and so on. When the slide show function is activated, the system will automatically enlarge the thumbnail image that the indicator frame happens to be stationed on as shown in FIG. 9. As shown in FIG. 9, the indicator frame stations on the first thumbnail. Thus, the rapid previewing starts from the number 1 thumbnail. After a preset interval (a few seconds in the present embodiment), the number 2 thumbnail is automatically enlarged and so on until the very last thumbnail is displayed or a stop previewing instruction is issued by the user (in step 920).

In general, the displaying sequence in the previewing can be prescribed according to a set of predefined directional instructions. FIG. 10 shows an image previewing sequence having a top to bottom and then left to right algorithm. In the diagram on the left side of FIG. 1, the indicator frame stations on the number 4 thumbnail. Because the previewing sequence is from top to bottom and then from left to right, the next enlarge thumbnail is the number 5 thumbnail. Furthermore, the previewing ends after the number 7 thumbnail is displayed because there are only seven thumbnail files in FIG. 10. FIG. 9 shows an image previewing sequence having a left to right and then top to bottom algorithm. Obviously, the previewing sequence provided in the present embodiment should by no means limit the scope of the present invention.

The present invention utilizes a display apparatus to implement the steps called for in the aforementioned displaying and previewing method. FIG. 12 is a diagram showing the relative configuration of various components in a display apparatus according to the present invention. As shown in FIG. 12, the display apparatus mainly comprises an image buffer storage device 1302, a display buffer storage device 1304, a processor 1306 and a display monitor 1308. The image buffer storage device 1302 holds raw images retrieved from a memory card 1300 and provides the indicator image corresponding to the instruction signal of a particular raw image. The processor 1306 compresses the raw image into a thumbnail image and an indicator image and retrieves one of the indicator images corresponding to the instruction signal of a particular raw image. The indicator image is larger than every thumbnail image but smaller than every raw image. The display buffer storage device 1304 holds thumbnail images or indicator images temporarily and outputs the thumbnail images and the indicator images to the display monitor 1308.

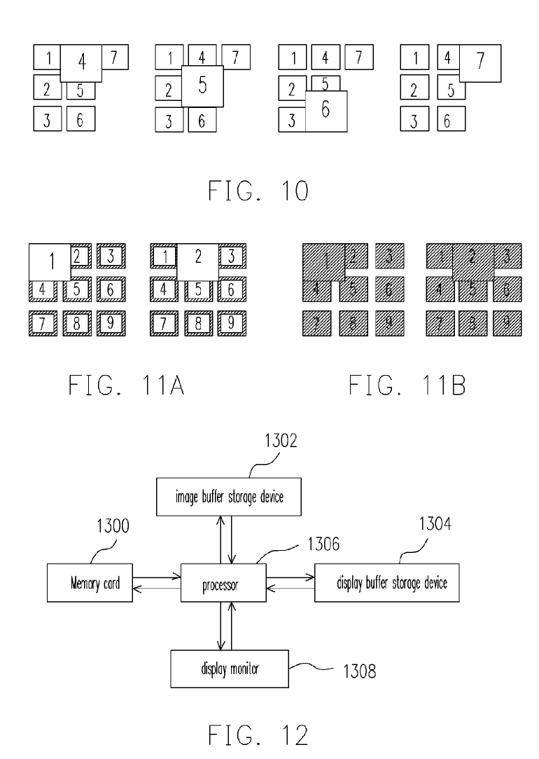

Aside from providing a user with innovative and improved interface, the user interface must be easy to understand and easy to use and meet market expectations. The displaying method of the present invention improves the previewing mode. As shown in FIGS. 11A and 11B, an enlarged preview image of the number 1 thumbnail is obviously more prominent than the other eight thumbnails so that the user can proceed with the next level of instruction from the number 1 thumbnail. Comparing the displaying mode between FIGS. 3A and 11A on one hand and FIGS. 3B and 11B on the other, enlarged preview image of the latter is much clearer than the former.

When the preview image is enlarged in the displaying and previewing method of the present invention, it is much easier for the user to distinguish between alternative images and executes the next level of instructions appropriately. In the meantime, the hierarchical display concept also highlights the position of the indicator frame and renders the displayed image a lot clearer. In addition, the enlargement also adds some dynamic character to the man-machine interface and the slide show previewing method also waives the need for a user to select and peruse the image one-by-one before choosing the desired one.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A displaying method for displaying images on a display apparatus, comprising the steps of:
a. reading out a plurality of raw images;
b. compressing the raw images into a plurality of thumbnail images;
c. displaying the thumbnail images on the display apparatus;
d. receiving a first instruction signal;
e. retrieving the raw image corresponding to the first instruction signal and compressing the raw image to form a first indicator image; and
f. displaying the first indicator image on the display apparatus.

2. The displaying method of claim 1, wherein after the step of displaying the first indicator image on the display apparatus, further comprises the following steps:
g. receiving a second instruction signal;
h. displaying the thumbnail images on the display apparatus;
i. retrieving the raw image corresponding to the second instruction signal and compressing the raw image into a second indicator image;
j. displaying the second indicator image on the display apparatus.

3. The displaying method of claim 1, wherein the thumbnail images are shrunk raw images reduced according to a fixed proportion.

4. The displaying method of claim 1, wherein the step f is executed after a period of delay from the step d.

5. The displaying method of claim 4, wherein the step e is executed during the period of delay.

6. The displaying method of claim 2, wherein the step j is executed after a period of delay from the step g.

7. The displaying method of claim 6, wherein the steps h˜i are executed during the period of delay.

8. A previewing method for displaying images on a display apparatus, comprising the steps of:
a. reading a plurality of raw images;
b. compressing the raw images into a plurality of thumbnail images;
c. displaying the thumbnail images on the display apparatus;
d. receiving an instruction signal;
e. retrieving the raw image corresponding to the instruction signal and compressing the raw image into an indicator image;
f. displaying the indicator image on the display apparatus;
g. displaying the thumbnail images on the display apparatus after a predefined period; and
h. compressing the next raw image to form the indicator image and repeating the step f and g a number of times;
i. repeating the step e, f and g until the predefined sequence is completed or a stop signal is issued.

9. The previewing method of claim 8, wherein the predefined display sequence comprises displaying images from the top to the bottom and then from the left to the right on the display apparatus.

10. The previewing method of claim 8, wherein the predefined display sequence comprises displaying images from the left to the right and then from the top to the bottom on the display apparatus.

11. The previewing method of claim 8, wherein the thumbnail images are shrunk raw images reduced according to a fixed ratio.

12. The previewing method of claim 8, wherein the step f is executed after a period of delay from the step d.

13. The previewing method of claim 12, wherein the step e is executed during the period of delay.

14. A display apparatus, comprising:
an image buffer storage device for holding a plurality of raw images;
a processor coupled to the image buffer storage device for compressing the raw images into a plurality of thumbnail images, compressing the raw images into a plurality of indicator images and retrieving an indicator image corresponding to the instruction signal of the raw image, wherein the indicator image has a size greater than every thumbnail image but smaller than every raw image;
a display buffer storage device coupled to the image buffer storage device and the processor for holding the thumbnail images and the indicator images temporarily and outputting the images; and
a display monitor coupled to the display buffer storage device for displaying the thumbnail images and the indicator images.
